(19) United States
(12) Patent Application Publication
(10) Pub. No.: US 2024/0420882 A1
(43) Pub. Date: Dec. 19, 2024

(54) INDUCTOR COMPONENT

(71) Applicant: Murata Manufacturing Co., Ltd., Kyoto-fu (JP)

(72) Inventors: Tarou TSUJIBAYASHI, Nagaokakyo-shi (JP); Masashi MIYAMOTO, Nagaokakyo-shi (JP)

(73) Assignee: Murata Manufacturing Co., Ltd., Kyoto-fu (JP)

(21) Appl. No.: 18/679,789

(22) Filed: May 31, 2024

(30) Foreign Application Priority Data
Jun. 14, 2023 (JP) 2023-097705

(51) Int. Cl. H01F 27/30; H01F 27/24; H01F 27/29; H01F 27/32

(52) U.S. Cl. CPC H01F 27/306; H01F 27/24; H01F 27/29; H01F 27/32

(57) ABSTRACT

In an inductor component, the winding return portions of multilayer winding portions that are embedded in a resin coating member present at positions that face a surface other than a winding core top surface of a winding core portion, and, of turns of a wire that constitute a first layer of each of the multilayer winding portions that is closest to the peripheral surface of the winding core portion, adjacent turns of the wire that are located between adjacent winding portions of the multilayer winding portions are in contact with each other or form a gap that is equal to or smaller than the radius of the wire.

### CROSS-REFERENCE TO RELATED APPLICATION

This application claims benefit of priority to Japanese Patent Application No. 2023-097705, filed Jun. 14, 2023, the entire content of which is incorporated herein by reference.

### BACKGROUND

### Technical Field

The present disclosure relates to an inductor component, and more particularly, to an inductor component including a drum-shaped core having a winding core portion and a wire wound around the winding core portion of the drum-shaped core to form a plurality of layers.

### Background Art

For example, Japanese Unexamined Patent Application Publication No. 2016-86034 describes an inductor component in which a wire is wound around a winding core portion of a drum-shaped core, and the wire is wound via a winding return portion through which the wire moves from a lower layer to an upper layer to form a multilayer winding portion including a plurality of layers.

FIG. 15 is taken from FIG. 5 in Japanese Unexamined Patent Application Publication No. 2016-86034 and illustrates, in plan view, a conventional inductor component 1 related to the present disclosure.

Referring to FIG. 15, the inductor component 1 includes a drum-shaped core 5 including a winding core portion 2 and first and second brim portions 3 and 4 provided at end portions of the winding core portion 2 that are opposite to each other in the axial direction of the winding core portion 2, and a wire 6 wound around the winding core portion 2.

The first brim portion 3 and the second brim portion 4 are provided with a first terminal electrode and a second terminal electrode, respectively, to which the end portions of the wire 6 are connected, but these terminal electrodes are not illustrated in FIG. 15. The first brim portion 3 and the second brim portion 4 have brim bottom surfaces that face a mounting board (not illustrated) and have a first terminal electrode and a second terminal electrode, respectively. However, the brim bottom surfaces are not illustrated in FIG. 15, but brim top surfaces 7 and 8 that face away from the brim bottom surfaces are illustrated. In addition, in the winding core portion 2 illustrated in FIG. 15, the winding core top surface 9 facing away from the winding core bottom surface facing the mounting board faces away from the drawing sheet.

The wire 6 forms multilayer winding portions M1 and M2 in which the wire 6 is wound to form a plurality of layers with winding return portions R1 and R2 interposed between a lower layer and an upper layer. In addition, the multilayer winding portions M1 and M2 are distributed at a plurality of positions in the axial direction of the winding core portion 2.

The multilayer winding portions M1 and M2 increase the number of turns of the wire 6 as much as possible in a limited space for winding of the wire 6 provided by the winding core portion 2, thereby enabling improvement of the inductance of the inductor component 1.

### SUMMARY

Although not described in Japanese Unexamined Patent Application Publication No. 2016-86034, the inductor component 1 may further include a resin coating member that extends across the brim top surface 7 of the first brim portion 3 and the brim top surface 8 of the second brim portion 4. When the resin coating member is made of, for example, a resin containing ferrite powder or metal magnetic powder, and the drum-shaped core 5 is made of, for example, a ferrite or a resin containing ferrite powder or metal magnetic powder, a closed magnetic path can be formed by the drum-shaped core 5 and the resin coating member.

When the resin coating member is provided to extend across the brim top surface 7 of the first brim portion 3 and the brim top surface 8 of the second brim portion 4, a portion of the wire 6 located close to the winding core top surface 9 of the winding core portion 2 is buried in the resin coating member.

As described above, in FIG. 15, the winding core portion 2 is illustrated with the winding core top surface 9 facing away from the drawing sheet. As illustrated in FIG. 15, relatively large gaps G are formed between turns of the wire 6 in portions that cover the winding core top surface 9 and in which the winding return portions R1 and R2 are present.

In this case, since the resin coating member significantly increases in thickness in a portion in which the resin coating member fills the gap G, the volume of the resin that fills the gap G significantly increases. It is known that the stress load due to expansion and contraction of resin generally increases as the volume of the resin increases. Accordingly, when the volume of resin that fills the gap G significantly increases as described above, the stress load due to expansion and contraction increases, resulting in local concentration of stress in the resin coating member.

In addition, the presence of the winding return portions R1 and R2 in portions that cover the winding core top surface 9 further increases the degree of unevenness in the thickness of the resin coating member.

This can cause cracks to occur in the resin coating member.

Accordingly, the present disclosure provides an inductor component in which cracks are less likely to occur in the resin coating member.

An inductor component according to the present disclosure includes a drum-shaped core including a winding core portion, a first brim portion, and a second brim portion, with the first brim portion and the second brim portion being provided at end portions of the winding core portion that are opposite to each other in an axial direction of the winding core portion. The inductor component further includes a wire wound around the winding core portion, the wire having a circular cross section; and a first terminal electrode and a second terminal electrode provided in the first brim portion and the second brim portion, respectively, with first and second end portions of the wire being connected to the first terminal electrode and the second terminal electrode, respectively.

The winding core portion includes an outer peripheral surface having at least a winding core bottom surface facing a mounting board and a winding core top surface facing away from the winding core bottom surface, and each of the first brim portion and the second brim portion includes an outer peripheral surface having at least a brim bottom surface facing the mounting board and a brim top surface facing away from the brim bottom surface.

The first terminal electrode and the second terminal electrode are provided at least on the brim bottom surface of the first brim portion and the brim bottom surface of the second brim portion, respectively.

The inductor component according to the present disclosure further includes a resin coating member that extends across the brim top surface of the first brim portion and the brim top surface of the second brim portion and in which a portion of the wire located close to the winding core top surface of the winding core portion is buried.

The wire forms a multilayer winding portion in which the wire is wound to form a plurality of layers with a winding return portion interposed between a lower layer and an upper layer.

The present disclosure has the following structure to solve the technical problems described above.

The winding return portion is present at a position that covers a portion of the outer peripheral surface of the winding core portion excluding the winding core top surface.

In addition, the plurality of multilayer winding portions are distributed at a plurality of positions in the axial direction of the winding core portion. Also, of turns of the wire that constitute the first layer of each of the multilayer winding portions that is closest to the peripheral surface of the winding core portion, adjacent turns of the wire that are located between adjacent multilayer winding portions of the multilayer winding portions are in contact with each other or form a gap that is equal to or smaller than the radius of the wire.

According to the present disclosure, since adjacent turns of the wire forming the first layer that are located between the adjacent multilayer winding portions are in contact with each other or form a gap that is equal to or smaller than the radius of the wire, the volume of the resin coating member can be suppressed from partially increasing significantly.

In addition, since the winding return portion can be prevented from being located at a position that covers the winding core top surface in the multilayer winding portion, the degree of unevenness in the thickness of the resin coating member provided along the winding core top surface can be reduced.

Accordingly, cracks are less likely to occur in the resin coating member.

### BRIEF DESCRIPTION OF THE DRAWINGS

FIG. 1 is a front view illustrating the inductor component according to an embodiment of the present disclosure in which a resin coating member is indicated by a dotted line;

FIG. 2 is a plan view of the inductor component illustrated in FIG. 1;

FIG. 3 is a bottom view of the inductor component illustrated in FIG. 1;

FIG. 4 is a bottom view illustrating a relatively early stage of a winding process of a wire of the inductor component illustrated in FIG. 1;

FIG. 5 is a bottom view illustrating a stage subsequent to the stage of the winding process of the wire illustrated in FIG. 4;

FIG. 6 is a bottom view illustrating a stage subsequent to the stage of the winding process of the wire illustrated in FIG. 5;

FIG. 7 is a bottom view illustrating a stage subsequent to the stage of the winding process of the wire illustrated in FIG. 6;

FIG. 8 is a bottom view illustrating a stage subsequent to the stage of the winding process of the wire illustrated in FIG. 7;

FIG. 9 is a bottom view illustrating a stage subsequent to the stage of the winding process of the wire illustrated in FIG. 8;

FIG. 10 is a bottom view illustrating a stage subsequent to the stage of the winding process of the wire illustrated in FIG. 9;

FIG. 11 is a bottom view illustrating a stage subsequent to the stage of the winding process of the wire illustrated in FIG. 10;

FIG. 12 is a bottom view illustrating a stage subsequent to the stage of the winding process of the wire illustrated in FIG. 11;

FIGS. 13A to 13F are sectional views schematically illustrating the winding order of the wire of the inductor component illustrated in FIG. 1;

FIG. 14 is a diagram for describing another embodiment of the present disclosure and corresponds to FIG. 13F; and

FIG. 15 is taken from FIG. 5 in Japanese Unexamined Patent Application Publication No. 2016-86034 and illustrates, in plan view, a conventional inductor component 1 related to the present disclosure.

### DETAILED DESCRIPTION

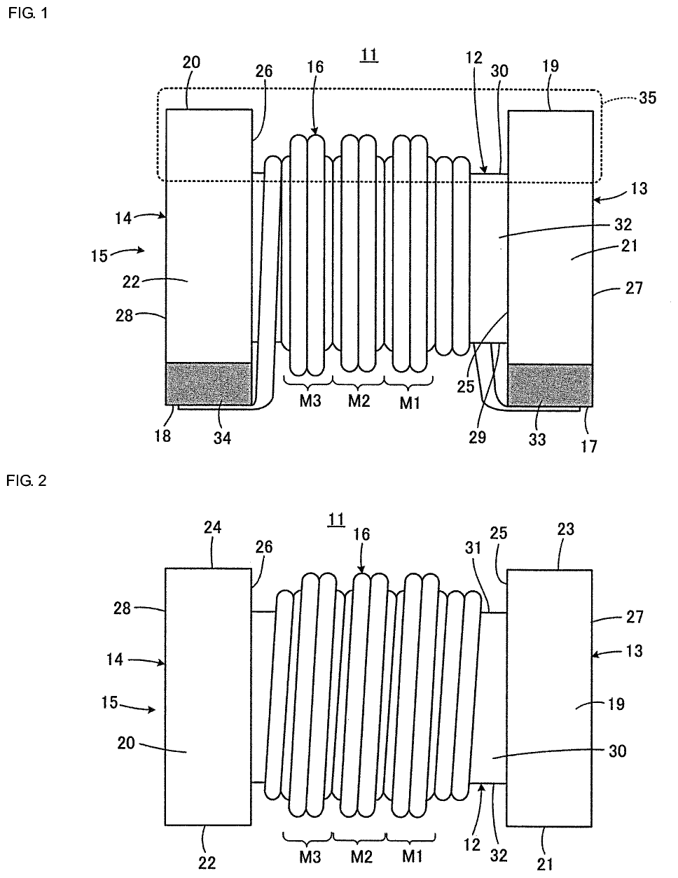

Referring to FIGS. 1 to 3, an inductor component 11 according to an embodiment of the present disclosure includes a drum-shaped core 15 including a winding core portion 12 and first and second brim portions 13 and 14 that are provided at end portions of the winding core portion 12 that are opposite to each other in the axial direction of the winding core portion 12 and a wire 16 wound around the winding core portion 12.

The drum-shaped core 15 is made of a non-conductive material, more specifically, a non-magnetic material, such as alumina, a magnetic material, such as ferrite, a resin, or the like. The resin preferably contains, for example, ferrite powder or metal magnetic powder as a filler. The winding core portion 12, the first brim portion 13, and the second brim portion 14 of the drum-shaped core 15 have a rectangular prism shape with a rectangular cross section. The corners and the angles of the drum-shaped core 15 including the rectangular prism-shaped winding core portion 12 and the rectangular prism-shaped brim portions 13 and 14 may be chamfered.

More specifically, the first brim portion 13 has, on the outer peripheral surface thereof, a brim bottom surface 17 facing a mounting board (not illustrated), a brim top surface 19 facing away from the brim bottom surface 17, and a first brim side surface 21 and a second brim side surface 23 facing away from each other and coupling the brim bottom surface 17 and the brim top surface 19 to each other. In addition, the first brim portion 13 has an inner end surface 25 facing the winding core portion 12 and an outer end surface 27 facing away from the inner end surface 25.

Similarly, the second brim portion 14 includes, on the outer peripheral surface thereof, a brim bottom surface 18 facing the mounting board, a brim top surface 20 facing away from the brim bottom surface 18, and a first brim side surface 22 and a second brim side surface 24 facing away from each other and coupling the brim bottom surface 18 and the brim top surface 20 to each other. In addition, the second brim portion 14 has an inner end surface 26 facing the winding core portion 12 and an outer end surface 28 facing away from the inner end surface 26.

The winding core portion 12 has an outer peripheral surface that includes a winding core bottom surface 29 facing the mounting board, a winding core top surface 30 facing away from the winding core bottom surface 29, and a first winding core side surface 31 and a second winding core side surface 32 facing away from each other and coupling the winding core bottom surfaces 29 and the winding core top surfaces 30 to each other.

The wire 16 has a circular cross section. The wire 16 is made from a copper wire insulated with a resin, such as polyesterimide.

The inductor component 11 includes a first terminal electrode 33 and a second terminal electrode 34 that are provided in the first brim portion 13 and the second brim portion 14, respectively, and to which the end portions of the wire 16 are connected. The forming regions of the first terminal electrode 33 and the second terminal electrode 34 are indicated by dark shading in the drawing.

The first terminal electrode 33 is provided on the brim bottom surface 17 of the first brim portion 13 and is preferably provided to extend from the brim bottom surface 17 to a portion of the first brim side surface 21, a portion of the second brim side surface 23, a portion of the inner end surface 25, and a portion of the outer end surface 27 that are adjacent to the brim bottom surface 17. Similarly, the second terminal electrode 34 is provided on the brim bottom surface 18 of the second brim portion 14 and is preferably provided to extend from the brim bottom surface 18 to a portion of the first brim side surface 22, a portion of the second brim side surface 24, a portion of the inner end surface 26, and a portion of the outer end surface 28 that are adjacent to the brim bottom surface 18.

The first terminal electrode 33 and the second terminal electrode 34 are formed by, for example, baking a conductive paste containing silver as a conductive component, and Ni plating, Cu plating, and Sn plating may be applied sequentially thereon as necessary. Alternatively, the terminal electrodes 33 and 34 may be provided by fixing terminal fittings made from conductive metal plates to the brim portions 13 and 14.

As illustrated by a dotted line in FIG. 1, the inductor component 11 includes a resin coating member 35 that extends across the brim top surface 19 of the first brim portion 13 and the brim top surface 20 of the second brim portion 14 and in which a portion of the wire 16 located close to the winding core top surface 30 of the winding core portion 12 is buried. The resin coating member 35 is made of a resin and preferably includes ferrite powder or metal magnetic powder. An ultraviolet curing resin is advantageously used as the resin. It should be noted that the resin coating member is not illustrated in the drawings other than FIG. 1.

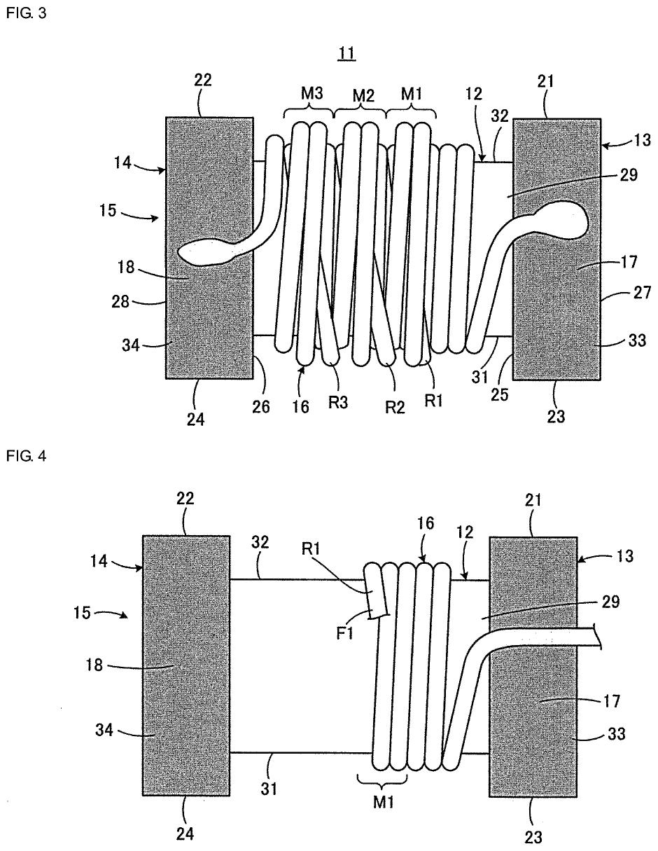

The wire 16 wound around the winding core portion 12 forms three multilayer winding portions M1, M2, and M3 in which the wire 16 is wound to form a plurality of layers with the winding return portions R1, R2, and R3 (see FIG. 3) interposed between a lower layer and an upper layer. The three multilayer winding portions M1, M2, and M3 are disposed in the axial direction of the winding core portion 12.

In the embodiment, each of the multilayer winding portions M1, M2, and M3 includes the first layer closest to the peripheral surface of the winding core portion 12, and a second layer that is wound around the outer periphery of the first layer. The second layer is fitted to a recessed portion formed between adjacent turns of the wire 16 that form the first layer.

The winding return portions R1, R2, and R3 are present at positions that cover some portions of the outer peripheral surface of the winding core portion 12 excluding the winding core top surface 30. In the embodiment, the winding return portions R1, R2, and

R3 are present at positions that cover the winding core bottom surface 29 of the outer peripheral surface of the winding core portion 12, as is clear from FIG. 3, which is a bottom view of the inductor component 11 illustrating the winding return portions R1, R2, and R3.

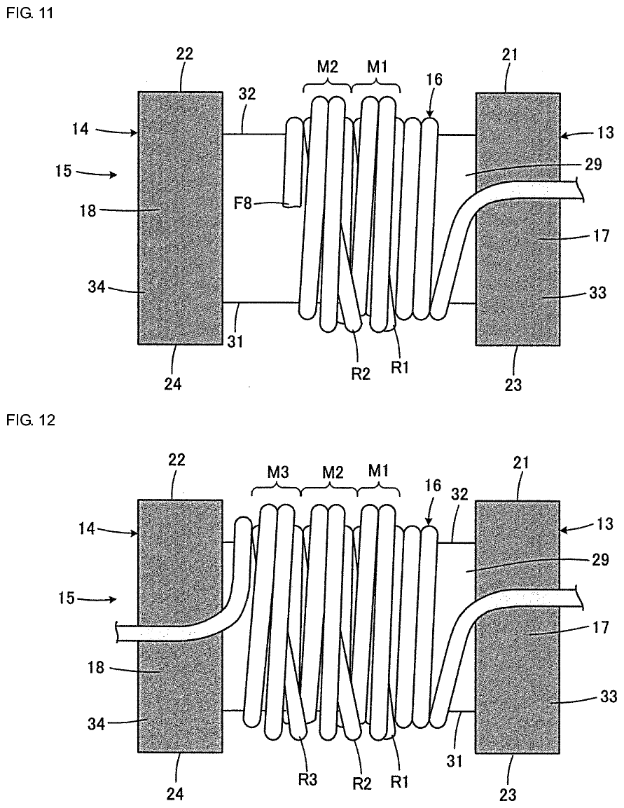

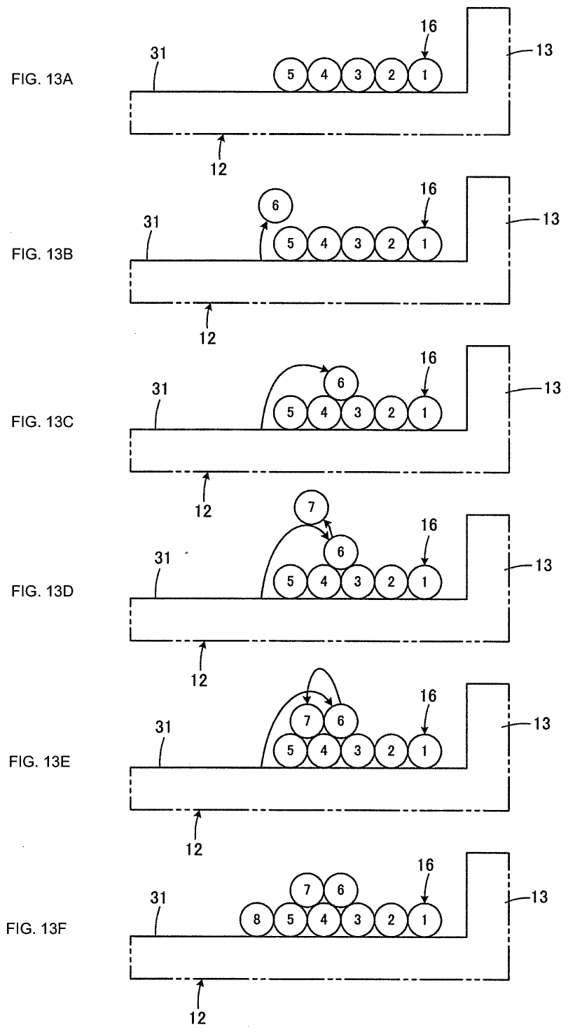

Next, details of the winding state of the wire 16 will be described with reference to mainly FIGS. 4 to 12 and FIGS. 13A to 13F. FIGS. 4 to 12 correspond to FIG. 3 and illustrate the drum-shaped core 15 from the bottom. While the wire 16 is spirally wound around the winding core portion 12, the wire 16 is guided from a position that covers the winding core bottom surface 29 to a position that covers the first winding core side surface 31. FIGS. 13A to 13F are sectional views illustrating the state of the wire 16 on the first core side surface 31 while the wire 16 is being wound. In FIGS. 13A to 13F, numerals in the cross sections of the wire 16 indicate the ordinal numbers of turns counting from the first brim portion 13.

The winding state of the wire 16 can be understood with reference to FIGS. 4 to 12 in sequence.

First, as illustrated in FIG. 4, the wire 16 is spirally wound around the winding core portion 12, for example, five turns from the first brim portion 13 to the second brim portion 14 to form the first layer. A portion of the first layer wound here is the first layer of the first multilayer winding portion M1. The state up to this point corresponds to the state illustrated in FIG. 13A.

Next, as illustrated similarly in FIG. 4, a tip F1 of the wire 16 is directed in a return direction to form the winding return portion R1 with the wound wire 16. This state corresponds to the state illustrated in FIG. 13B. In FIG. 13B, the sixth turn of the wire 16 floats in the air.

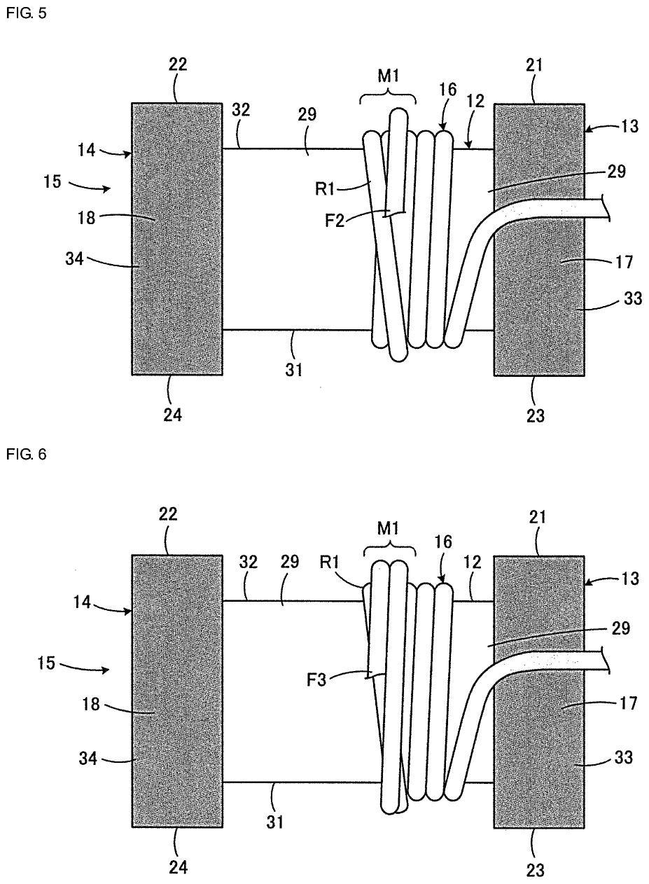

Next, as illustrated in FIG. 5, after the wire 16 forms the winding return portion R1, the wire 16 is wound to form the second layer of the first multilayer winding portion M1. At this time, a tip F2 of the wire 16 rides over the top of the winding return portion R1.

When the wire 16 is further wound from the state illustrated in FIG. 5, as illustrated in FIG. 13C, the sixth turn of the wire 16 is fitted to the recessed portion formed between the third turn and the fourth turn of the wire 16 that form the first layer and starts forming the second layer on the outer peripheral side of the first layer.

Next, as illustrated in FIG. 6, the wire 16 is wound to form the second layer. In FIG. 6, a tip of the wire 16 is indicated by F3.

As illustrated in FIG. 13D, when the wire 16 is further wound from the state illustrated in FIG. 6, the seventh turn of the wire 16 is located to face a portion between the fourth turn and the fifth turn of the wire 16 that form the first layer.

Next, as illustrated in FIG. 13E, the seventh turn of the wire 16 forms the second layer while being fitted to the recessed portion formed between the fourth turn and the fifth the turn of the wire 16 that form the first layer.

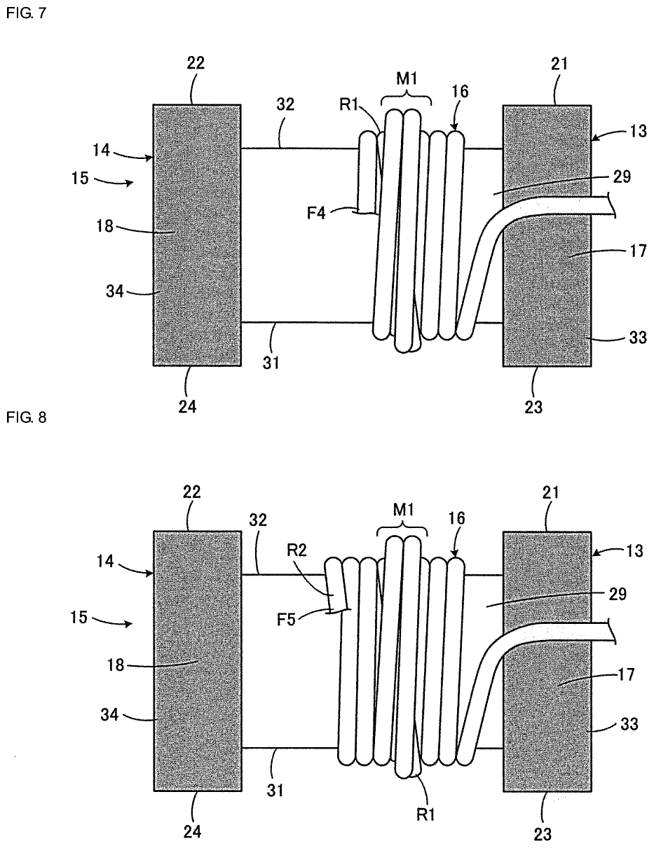

Next, as illustrated in FIG. 7, after the wire 16 is wound two or more turns (two turns in the embodiment) in the second layer, the wire 16 moves from the second layer to the first layer, and, as can be seen from the illustrated position of a tip F4 of the wire 16, the wire 16 is wound again to form the first layer. This state corresponds to the state illustrated in FIG. 13F. As illustrated in FIG. 13F, the eighth turn of the wire 16 is positioned to form the first layer.

As illustrated in FIGS. 6 and 7 described above, in the embodiment, the travel direction parallel to the axial direction of the winding core portion 12 of the wire 16 spirally wound in the second layer is identical to the travel direction parallel to the axial direction of the wire 16 spirally wound in the first layer.

Next, the process substantially the same as the process described with reference to FIGS. 4 to 7 is repeated a predetermined number of times.

In brief, as illustrated in FIG. 8, after the wire 16 is wound a predetermined number of turns in the first layer, a tip F5 of the wire 16 is directed in the return direction such that the wire 16 forms the winding return portion R2.

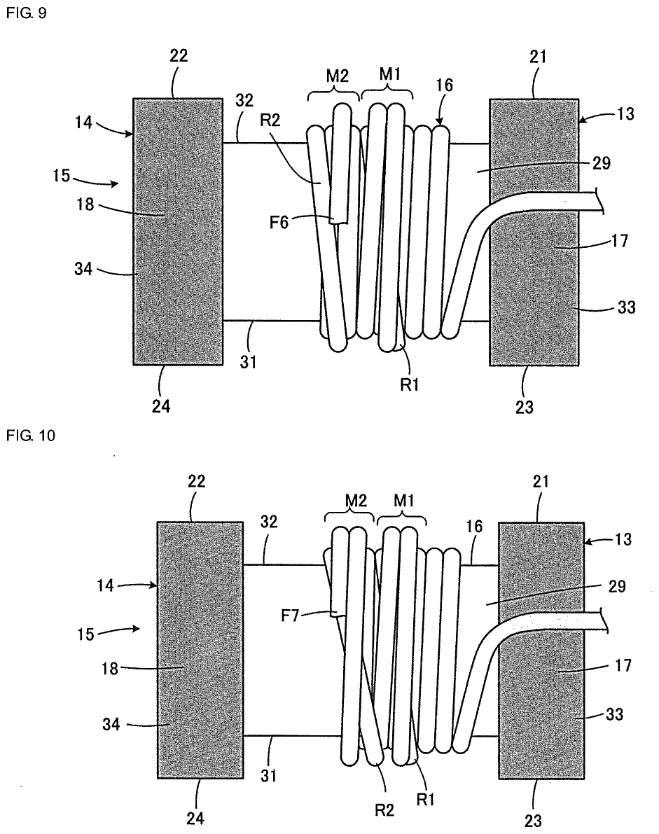

Next, as illustrated in FIG. 9, after the wire 16 forms the winding return portion R2, the wire 16 is wound to form the second layer of the second multilayer winding portion M2. At this time, a tip F6 of the wire 16 rides over the top of the winding return portion R2. Next, as illustrated in FIG. 10, the wire 16 is wound to further form the second layer of the second multilayer winding portion M2. In FIG. 10, the tip of the wire 16 is indicated by F7.

Next, as illustrated in FIG. 11, after being wound two or more turns (two turns in the embodiment) in the second layer, the wire 16 moves from the second layer to the first layer and is wound to form the first layer again as can be seen from the illustrated position of a tip F8 of the wire 16.

Next, the process substantially the same as the process described with reference to FIGS. 4 to 7 or FIGS. 8 to 11 is performed, and the state illustrated in FIG. 12 is ultimately obtained. In the state illustrated in FIG. 12, the end portions of the wire 16 are connected to the first terminal electrode 33 and the second terminal electrode 34, respectively, by, for example, thermal compression bonding. After this connection, the excess portions of the end portions of the wire 16 are cut and removed as illustrated in FIG. 3, and the resin coating member 35 illustrated in FIG. 1 is provided.

In FIG. 3, the wire 16 forms the three multilayer winding portions M1, M2, and M3 in which the wire 16 is wound to form two layers with the winding return portions R1, R2, and R3 interposed between the first layer and the second layer.

Since the winding return portions R1, R2, and R3 are present at positions that cover some portions of the outer peripheral surface of the winding core portion 12 excluding the winding core top surface 30, preferably, at positions that cover the winding core bottom surface 29, the winding structure of the wire 16 on the winding core top surface 30 is simplified. Accordingly, a concentration of stress in the resin coating member 35 provided to cover the winding core top surface 30 can be suppressed. In addition, the height of the wound wire 16 on the winding core top surface 30 can be suppressed.

In addition, the three multilayer winding portions M1, M2, and M3 are distributed at a plurality of positions in the axial direction of the winding core portion 12, and, of turns of the wire 16 that constitute the first layer of each of the multilayer winding portions that is closest to the peripheral surface of the winding core portion 12, adjacent turns of the wire 16 that are located between adjacent winding portions of the multilayer winding portions M1, M2, and M3 are in contact with each other or form a gap that is equal to or smaller than the radius of the wire 16. It should be noted that the radius of the wire 16 is the radius of the wire 16 including, for example, a center conductor made from a copper wire and an insulating coating made of a resin.

Accordingly, the volume of the resin coating member 35 can be suppressed from partially increasing significantly. In addition, since the winding return portions R1, R2, and R3 of the multilayer winding portions M1, M2, and M3 are located at positions that cover the winding core bottom surface 29, the degree of unevenness in the thickness of the resin coating member 35 can be reduced. Accordingly, cracks are less likely to occur in the resin coating member 35.

Particularly in the embodiment, not only adjacent turns of the wire 16 located between adjacent multilayer winding portions of the plurality of multilayer winding portions M1, M2 and M3, but also adjacent turns of the wire 16 that form the first layer excluding turns located at both end portions of the winding core portion 12 in the axial direction are in contact with each other or form a gap equal to or smaller than the radius of the wire 16. The gap between turns located at both end portions of the winding core portion 12 in the axial direction is likely to exceed the radius of the wire 16 because the wire 16 is guided to be connected to the terminal electrodes 33 and 34. It should be noted that all adjacent turns of the wire 16 that form the first layer including the turns located at both end portions of the winding core portion 12 in the axial direction may be in contact with each other or may form a gap equal to or smaller than the radius of the wire 16.

In addition, in the embodiment, the number of turns of the wire 16 that form the second layer in each of the multilayer winding portions M1, M2, and M3 is 2 or more. When the number of turns of the wire 16 that form the second layer is 2 or more, if the wire 16 moves from the second layer to the first layer, a gap between a turn of the wire 16 that is located in the first layer before and a turn of the wire 16 that newly moves to the first layer is less likely to be formed. In addition, the wire 16 that forms the second layer can be prevented from projecting relatively sharply from the outer peripheral surface of the outline of the wound wire 16. Accordingly, the above can also suppress a local concentration of stress on the resin coating member 35, ultimately making cracks less likely to occur in the resin coating member 35.

In addition, as can be seen from the states illustrated in FIGS. 1 to 3, in the embodiment, the wire 16 wound around the winding core portion 12 has a relatively regular shape and has a substantially symmetrical shape particularly in the vertical direction in the drawings. This can also suppress cracks from occurring in the resin coating member 35.

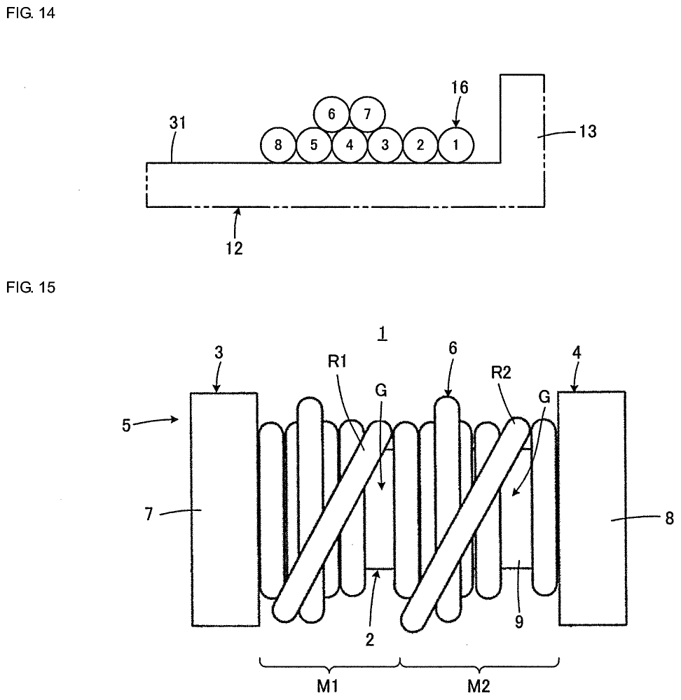

FIG. 14 is a diagram for describing another embodiment of the present disclosure and corresponds to FIG. 13F. As can be seen from the numerals in the cross sections of the wire 16 in FIG. 14, the travel direction parallel to the axial direction of the winding core portion 12 of the wire 16 spirally wound in the second layer is opposite to the travel direction parallel to the axial direction of the winding core portion 12 of the wire 16 spirally wound in the first layer. Accordingly, the travel direction parallel to the axial direction of the winding core portion 12 of the wire 16 in the second layer can be either of the two.

Although the present disclosure has been described through the embodiments illustrated in the drawings, various other modifications can be made within the scope of the present disclosure.

For example, the number of multilayer winding portions distributed in the axial direction of the winding core portion need only be two or more.

In addition, the number of turns and the number of layers of the wire in the multilayer winding portion can be changed arbitrarily according to the design. Moreover, the number of turns and the number of layers of the wire may differ between the multilayer winding portions.

In addition, components can be partially replaced or combined with each other between different embodiments of the present disclosure.

The present disclosure has the following aspects.

<1> An inductor component comprising a drum-shaped core including a winding core portion, a first brim portion, and a second brim portion, with the first brim portion and the second brim portion being provided at end portions of the winding core portion that are opposite to each other in an axial direction of the winding core portion; a wire wound around the winding core portion, the wire having a circular cross section; and a first terminal electrode and a second terminal electrode that are provided in the first brim portion and the second brim portion, respectively, with first and second end portions of the wire being connected to the first terminal electrode and the second terminal electrode, respectively. The winding core portion includes an outer peripheral surface having at least a winding core bottom surface facing a mounting board and a winding core top surface facing away from the winding core bottom surface. The first brim portion has an outer peripheral surface having at least a first brim bottom surface facing a mounting board and a first brim top surface facing away from the first brim bottom surface, and the second brim portion has an outer peripheral surface having at least a second brim bottom surface facing the mounting board and a second brim top surface facing away from the second brim bottom surface. The first terminal electrode and the second terminal electrode are provided in at least the first and second brim bottom surfaces of the first brim portion and the second brim portion, respectively. The inductor component further includes a resin coating member that extends across the first brim top surface of the first brim portion and the second brim top surface of the second brim portion, a portion of the wire located closer to the winding core top surface of the winding core portion being buried in the resin coating member. The wire forms a multilayer winding portion in which the wire is wound to form a plurality of layers with a winding return portion interposed between a lower layer and an upper layer. The winding return portion is present at a position that covers the outer peripheral surface of the winding core portion excluding the winding core top surface. A plurality of multilayer winding portions are distributed at a plurality of positions in the axial direction of the winding core portion, the multilayer winding portion being one of the plurality of multilayer winding portions. Also, of turns of the wire that constitute the first layer of each of the multilayer winding portions that is closest to the peripheral surface of the winding core portion, adjacent turns of the wire that are located between adjacent winding portions of the multilayer winding portions are in contact with each other or form a gap that is equal to or smaller than the radius of the wire.

<2> The inductor component according to <1>, wherein adjacent turns of the wire that form the first layer excluding turns located at both end portions in the axial direction of the winding core portion are in contact with each other or form a gap equal to or smaller than the radius of the wire.

<3> The inductor component according to <1> or <2>, wherein the winding return portion is present at a position that covers the winding core bottom surface of the outer peripheral surface of the winding core portion.

<4> The inductor component according to any one of <1> to <3>, wherein each of the multilayer winding portions includes the first layer and a second layer wound around an outer periphery of the first layer.

<5> The inductor component according to <4>, wherein two or more turns of the wire form the second layer in each of the multilayer winding portions.

<6> The inductor component according to <5>, wherein a travel direction parallel to the axial direction of the wire spirally wound in the second layer is identical to a travel direction parallel to the axial direction of the wire spirally wound in the first layer.

<7> The inductor component according to <5>, wherein a travel direction parallel to the axial direction of the wire spirally wound in the second layer is opposite to a travel direction parallel to the axial direction of the wire spirally wound in the first layer.

What is claimed is:

1. An inductor component comprising:
a drum-shaped core including a winding core portion, a first brim portion, and a second brim portion, the first brim portion and the second brim portion being at end portions of the winding core portion that are opposite to each other in an axial direction of the winding core portion;
a wire wound around the winding core portion, the wire having a circular cross section; and
a first terminal electrode and a second terminal electrode that are in the first brim portion and the second brim portion, respectively, first and second end portions of the wire being connected to the first terminal electrode and the second terminal electrode, respectively,
wherein
the winding core portion includes an outer peripheral surface having at least a winding core bottom surface facing a mounting board and a winding core top surface facing away from the winding core bottom surface,
the first brim portion has an outer peripheral surface having at least a first brim bottom surface facing a mounting board and a first brim top surface facing away from the first brim bottom surface, and the second brim portion has an outer peripheral surface having at least a second brim bottom surface facing the mounting board and a second brim top surface facing away from the second brim bottom surface,
the first terminal electrode and the second terminal electrode are in at least the first and second brim bottom surfaces of the first brim portion and the second brim portion, respectively,
the inductor component further includes a resin coating member that extends across the first brim top surface of the first brim portion and the second brim top surface of the second brim portion, a portion of the wire located closer to the winding core top surface of the winding core portion being buried in the resin coating member,
the wire configures a multilayer winding portion in which the wire is wound to configure a plurality of layers with a winding return portion interposed between a lower layer and an upper layer,
the winding return portion is at a position that covers the outer peripheral surface of the winding core portion excluding the winding core top surface,
a plurality of multilayer winding portions are distributed at a plurality of positions in the axial direction of the winding core portion, the multilayer winding portion being one of the plurality of multilayer winding portions, and
of turns of the wire that are the first layer of each of the multilayer winding portions that is closest to the peripheral surface of the winding core portion, adjacent turns of the wire that are located between adjacent winding portions of the multilayer winding portions are in contact with each other or provide a gap that is equal to or smaller than a radius of the wire.

2. The inductor component according to claim 1, wherein
adjacent turns of the wire that are the first layer excluding turns located at both end portions in the axial direction of the winding core portion are in contact with each other or provide a gap equal to or smaller than the radius of the wire.

3. The inductor component according to claim 1, wherein
the winding return portion is at a position that covers the winding core bottom surface of the outer peripheral surface of the winding core portion.

4. The inductor component according to claim 1, wherein
each of the multilayer winding portions includes the first layer and a second layer wound around an outer periphery of the first layer.

5. The inductor component according to claim 4, wherein
two or more turns of the wire configure the second layer in each of the multilayer winding portions.

6. The inductor component according to claim 5, wherein
a travel direction parallel to the axial direction of the wire spirally wound in the second layer is identical to a travel direction parallel to the axial direction of the wire spirally wound in the first layer.

7. The inductor component according to claim 5, wherein
a travel direction parallel to the axial direction of the wire spirally wound in the second layer is opposite to a travel direction parallel to the axial direction of the wire spirally wound in the first layer.
